(19) United States
(12) Patent Application Publication
(10) Pub. No.: US 2011/0090411 A1
(43) Pub. Date: Apr. 21, 2011

(54) Deployable automotive video display

(76) Inventor: Darrell R. Finneman, Albany, OR (US)

(21) Appl. No.: 10/293,523

(22) Filed: Nov. 12, 2002

Related U.S. Application Data
(63) Continuation of application No. 09/595,625, filed on Jun. 16, 2000, now abandoned.

(51) Int. Cl. H04N 5/655

(52) U.S. Cl. 348/837; 348/E05.132

(57) ABSTRACT

A stowable video display system is provided for mounting in a passenger compartment of a vehicle, the display unit including a base, a display screen, a pivotal coupling structure, a first position-fixing member and a second position-fixing member. The display screen is pivotally coupled to the base, and is pivotal between a stowed position in which the screen is not visible to a viewer, and a deployed position in which the screen is visible to a viewer. The deployed position is selected from positions within a continuous range of possible deployed positions. The pivotal coupling pivotally couples the screen to the base, and includes a dampening mechanism adapted to dampen the deployment of the screen. The first position-fixing member is on the base. The second position-fixing member is on the pivotal coupling structure, and is adapted to contact the first position-fixing member when the screen is deployed to hold the screen in any position within the continuous range of possible deployed positions.

### CROSS-REFERENCE TO RELATED APPLICATIONS

This application is a continuation of U.S. patent application Ser. No. 09/595,625, filed Jun. 16, 2000 and entitled “Deployable Automotive Video Display”.

### TECHNICAL FIELD

The present invention relates to a video display system adapted to be mounted in the passenger compartment of an automobile. More particularly, the invention concerns an automotive video display system with a display screen that may be pivoted between a stowed position and a deployed position, the deployed position being selected within a continuous range of possible deployed positions.

### BACKGROUND OF THE INVENTION

Automotive manufacturers have long sought to make passengers as comfortable as possible during travel, focusing both on the physical comfort and the entertainment of passengers. For example, vehicle sound systems have become standard accessories in most cars and trucks. In recent years, efforts have involved attempts to bring video technology into the passenger compartment, either in the form of a television, a computer, or a video game display.

Unfortunately, until recently, display units have been impractical as automotive accessories due to problems in mounting conventional display screens within an automobile. Furthermore, many automotive video display systems have been unable to meet consumer expectations due to difficulties in providing acceptable picture quality in a package of suitable size. However, with advancements in display technology, smaller display screens are now available with dramatically better picture qualities. Furthermore, it has become possible to separate some of the electronic circuitry from the display screen, thus allowing further reductions in the thickness of these display screens.

Though advances in display technology have increased the quality of display screens suitable for mounting in the passenger compartment of automobiles, various problems still exist regarding the placement and mounting of the display screens. For example, any display screen, no matter how small, may obstruct a passenger's view both within and outside of the automobile. Also, the presence of a video display system in an automobile may reduce the effective space and carrying capacity of the automobile, and the video display system may be susceptible to damage when transporting objects in the passenger compartment of the automobile.

Problems may also be encountered in the positioning of the video display system within the passenger compartment. Ideally, a display screen should be viewable by passengers of as many different heights as possible, and should be suitable for use by both adults and children. Although it is possible to place a display screen in a fixed position in the ideal viewing position for a passenger of average height, such an arrangement tends to reduce the utility of the display system to passengers of heights significantly different from the average, especially small children. One solution may be to provide a video display system with several discrete display screen positions between which the screen may be moved. However, this type of system would not allow for the fine adjustment of the display screen by each individual viewer. Thus, there remains a need for an improved video display system which includes a display screen adapted for adjustable positioning in an automobile.

### SUMMARY OF THE INVENTION

A stowable video display system is provided for mounting in a passenger compartment of a vehicle, the display unit including a base, a display screen, a pivotal coupling structure, a first position-fixing member and a second position-fixing member. The display screen is pivotally coupled with the base, and is pivotal between a stowed position in which the screen is not visible to a viewer, and a deployed position in which the screen is visible to a viewer. The deployed position is selected from positions within a continuous range of possible deployed positions. The pivotal coupling pivotally couples the screen to the base, and typically includes a dampening mechanism adapted to dampen the deployment of the screen. The first position-fixing member typically is mounted on the base. The second position-fixing member typically is mounted on the pivotal coupling structure, and is adapted to frictionally engage the first position-fixing member upon deployment of the screen, thereby holding the screen in a position within the continuous range of possible deployed positions.

### BRIEF DESCRIPTION OF THE DRAWINGS

FIG. 1 is a partially cutaway isometric view of a deployable automotive video display system according to the present invention, with the screen and control device in deployed positions.

FIG. 2 is a partially cutaway isometric view of the video display system similar to FIG. 1, but with the screen and control device in stowed positions.

FIG. 3 is an isometric view of a pair of pivotal coupling structures and the screen of the video display system of FIG. 1.

FIG. 4 is a partially broken-away side view of the video display system of FIG. 1, with the screen shown in a first deployed position in solid lines and in a second deployed position in dashed lines.

FIG. 5 is a side view of an automobile including the video display system of FIG. 1.

FIG. 6 is an enlarged view of the video display system of FIG. 5 taken from the area defined by line 6 of FIG. 5.

### DETAILED DESCRIPTION OF THE PREFERRED EMBODIMENTS

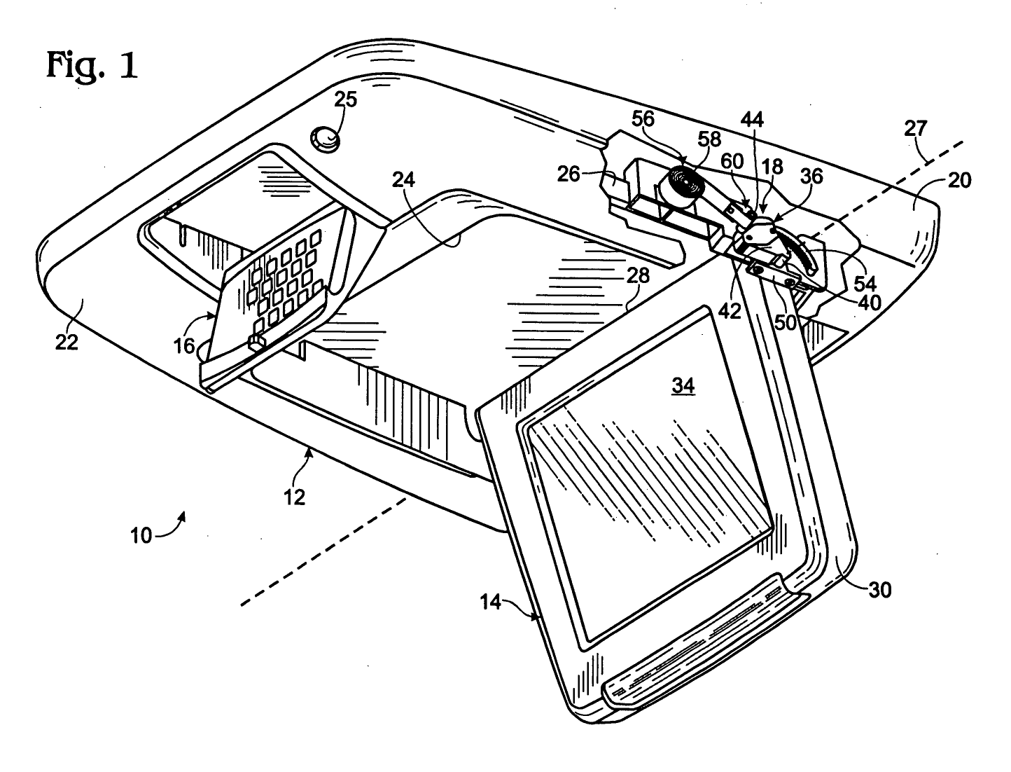

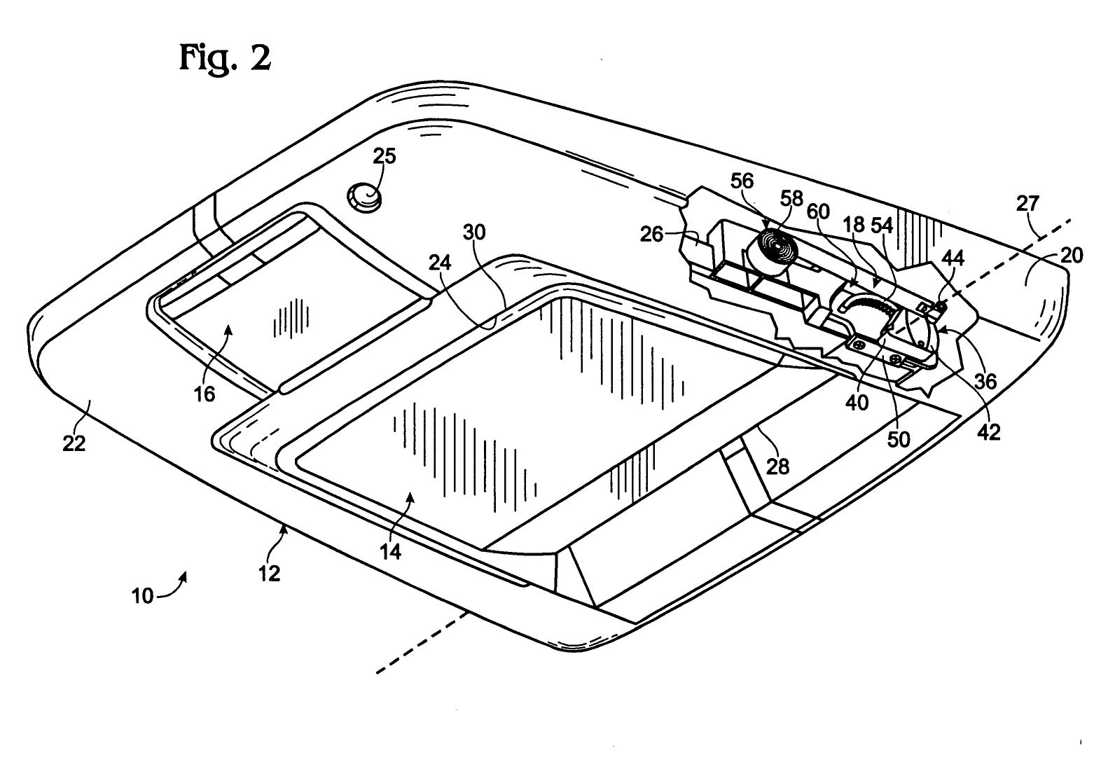

The present invention concerns a video display system that provides a wide range of precise positional adjustability. One such video display system is indicated generally at 10 in FIGS. 1-2, such system being adapted to be mounted to the ceiling of the passenger compartment in an automobile. Though the display may be configured to be viewable from any desired seat in the automobile, the display typically is viewable and controllable from the rear seat of the automobile.

Video display system 10 includes a base or housing 12 configured for mounting system 10 to the ceiling of the automobile, a display screen structure 14 on which a video image may be displayed, and a stowable control device 16 (operable by the rear seat passenger). Screen structure 14 may be pivoted between any of a range of deployed positions, an example of which is shown in FIG. 1. The video display system is shown with the screen structure in a stowed position in FIG. 2. System 10 also includes a dampened deployment mechanism, indicated generally at 18, the depicted dampened deployment mechanism being configured to accommodate placement of the screen in any position within a continuous range of possible deployed positions.

Base 12 may have many different configurations, depending on the functions to be performed by base 12 and the position at which base 12 is to be mounted in the automobile. For example, base 12 may house many of the electronics of system 10, and may protect screen structure 14 when it is in the stowed position. Furthermore, base 12 may be configured to reduce the amount of space taken by system 10 in the passenger compartment of the automobile.

In the depicted embodiment, base 12 has a thin profile to conserve interior space in the automobile and to minimize obstruction of occupants' views both within the automobile and of the outside world. Base 12 includes a front region 20 configured to be mounted toward the front of the automobile passenger compartment, and a back region 22 configured to be mounted toward the rear of the passenger compartment. A recess or cavity 24 is formed in base 12 to receive screen structure 14, either partially or fully, when the screen structure is in the stowed position. Base 12 may be embedded in the ceiling of the automobile so that screen structure 14 is flush with the ceiling of the automobile when in the stowed position, thus eliminating any impediment to the rear view of the driver.

Stowable control device 16 is coupled to base 12 adjacent back region 22 of base 12. The stowable control device also may include a latching mechanism, and associated release button 25, to allow control device 16 to be secured in, and released from, the stowed position thereof. Alternatively, system 10 may include a remote control device, either in addition to or in place of stowable control device 16. Storage for such a remote control device may be provided at a suitable location on or within base 12. For example, if the remote control device is used in place of stowable control device 16, the remote control device may be stored in base 12 in the cavity that would otherwise contain stowable control device 16. As a third alternative, system 10 may include a fixed control panel permanently mounted on base 12 or screen 14.

Base 12 also includes a frame 26. Frame 26 provides the basic support for system 10, and may be used to mount system 10 within an automobile. Frame 26 may be mounted to the automobile by any suitable mechanism, and may be installed either during the manufacture of the automobile or post-sale.

Screen structure 14 generally is adapted to display an image from a video source, and is pivotal out of view when not in use. Screen structure 14 is coupled to frame 26 on each side of frame 26. Screen structure 14 includes a front edge 28 and a rear edge 30. In the depicted embodiment, screen structure 14 is pivotally coupled to frame 26 in the front region 20 of base 12 along a pivot axis 27 that runs adjacent and parallel to front edge 28 of screen structure 14. A suitable latching mechanism (not shown) may be provided for selectively retaining screen structure 14 in the stowed position. Screen structure 14 is positioned generally parallel to the ceiling of an automobile when in the stowed position, and is deployed by first, unlatching the latching mechanism (not shown), and then, tilting rear edge 30 downward to reveal a viewing surface 34 to rear seat passengers. Viewing surface 34 may utilize any suitable flat panel display system, such as an DSTN or TFT LCD display, or a plasma display, for displaying an image to a viewer.

Screen structure 14 is coupled to frame 26 via one or more pivotal coupling structures 36. Each pivotal coupling structure houses a dampened deployment mechanism 18. FIG. 3 shows a pair of opposing pivotal coupling structures 36 attached to opposite sides of screen structure 14. Each pivotal coupling structure 36 includes a screen-coupling portion 38, a pivot bar 40, a body portion 42 and an urging system anchor 44. Screen-coupling portion 38 is adapted for attaching pivotal coupling structure 36 to screen structure 14, and may be attached to any suitable location on screen structure 14 by any suitable means. In the depicted embodiment, screen-coupling portion 38 has an elongate shape adapted to fit within screen structure 14, and includes one or more attachment points 46 for attaching screen-coupling portion 38 to the interior of screen structure 14 with a suitable fastener.

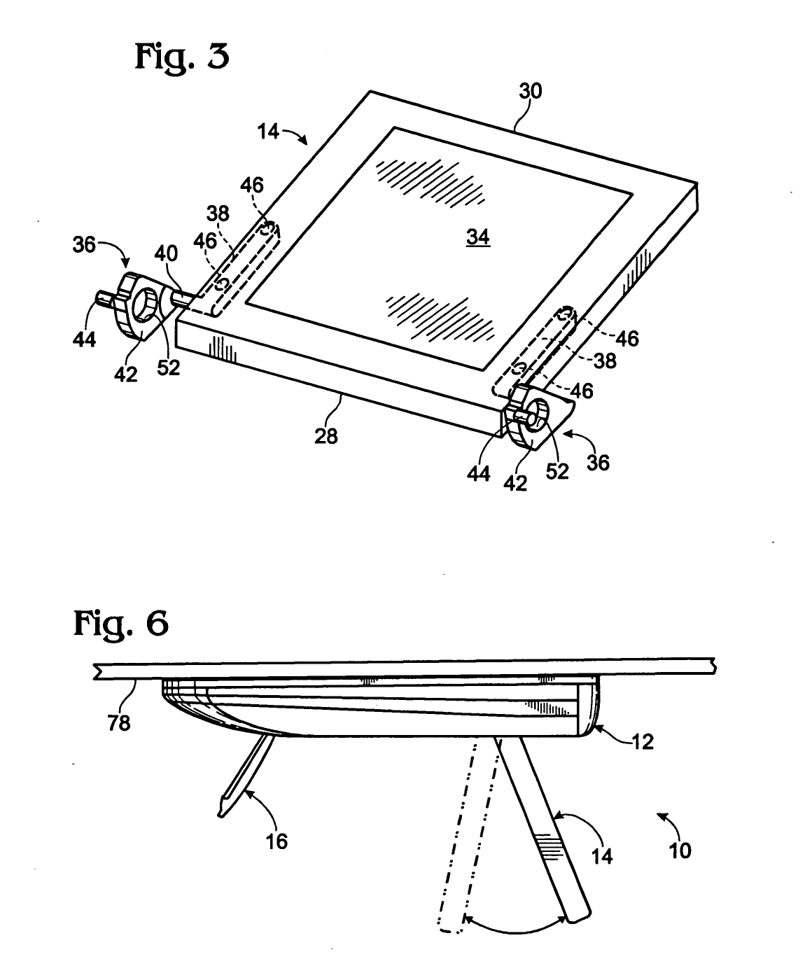

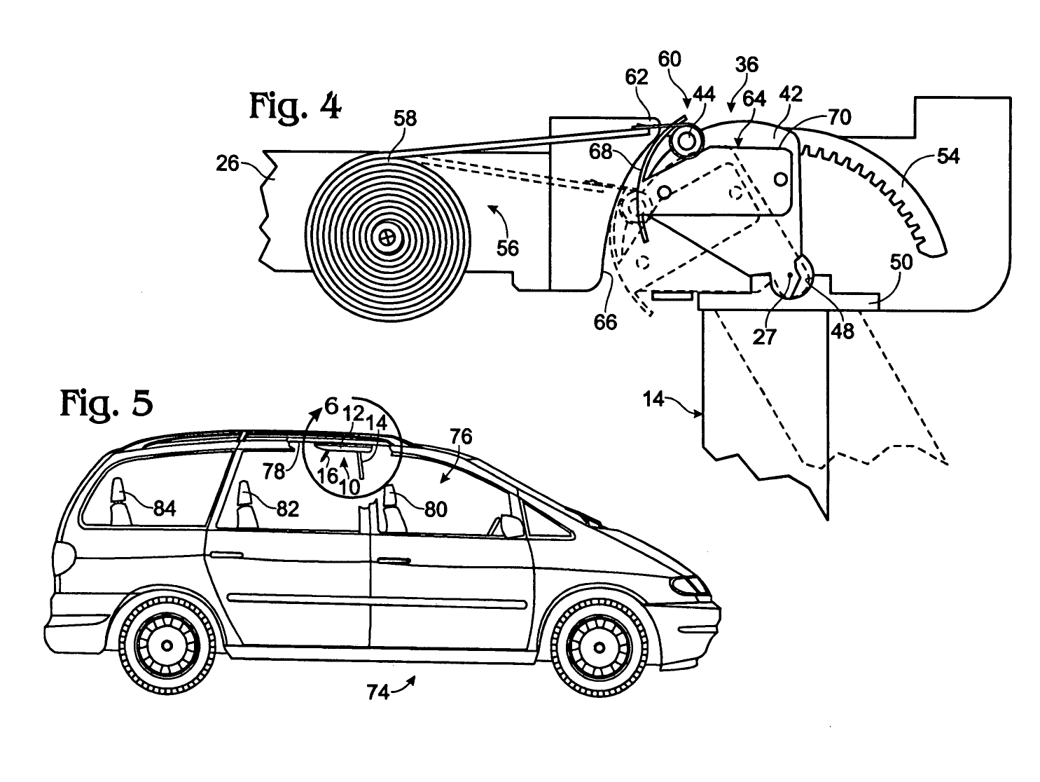

Each pivotal coupling structure 36 is coupled to frame 26 via pivot bar 40. Pivot bars 40 extend out of screen structure 14 at an approximate right angle relative to the elongate dimension of screen-coupling portion 38, and through apertures 48 in each side of frame 26 for rotation about axis 27. The structure of apertures 48 is shown in FIG. 4 (where a pivot bar 40 is broken away). Pivotal coupling structures 36 are positioned on screen structure 14 so that pivot bars 40 are aligned with pivotal axis 27 when screen structure 14 is coupled with frame 26. Each aperture 48 is formed from a combination of a notch in the edge of frame 26 and a suitable covering member, such as a plate 50, that may be attached to the edge of frame 26 over the notch. Screen structure 14 may be coupled to base 12 by first positioning pivot bars 40 in the notches formed in frame 26 and then fastening plates 50 over pivot bars 40.

Body portion 42, which is mounted on pivot bar 40, has the basic functions of linking pivot bar 40 with urging system anchor 44, and of housing various mechanical parts of dampened deployment mechanism 18. Dampened deployment mechanism 18 slows the deployment of screen structure 14 when screen structure 14 is unlatched, protecting screen structure 14 from damage and giving the deployment of screen structure 14 a high quality, luxurious feel. Each pivotal coupling structure 36 includes a cavity 52 formed in body portion 42 to house the dampened deployment mechanism. Cavity 52 is configured to hold a viscous fluid. An axle with one or more vanes (not shown) may be positioned in cavity 52 and mechanically coupled to a ring gear segment 54 that is formed on base 12 adjacent axis 27. Pivoting screen structure 14 between the stowed and deployed positions causes the axle to rotate, forcing the vanes to move through the viscous fluid. The friction of the vanes passing through the viscous fluid thus slows the deployment of screen structure 14. Body portion 42 may be formed from a commercially available mechanism, such as those available from ACE Controls, Inc. of Farmington Hills, Mich.

The deployment of screen structure 14 may occur by any suitable mechanism, such as by operator force, by gravity, under spring bias, or by motor-controlled operation. In the depicted embodiment, system 10 includes an urging system 56 that assists in the deployment of screen structure 14 with a spring bias. As described above, each pivotal coupling structure 36 includes an urging system anchor 44. A coil spring 58 that is coiled in a rest state is coupled both to urging system anchor 44 and to frame 26 at a location toward back region 22 of base 12. Urging system anchor 44 is configured to move away from coil spring 58 when screen structure 14 is stowed, causing coil spring 58 to uncoil. Coil spring 58 thus exerts an urging force on urging system anchor 44 when screen structure 14 is in the stowed position, and pulls screen structure 14 to a deployed position under a constant force when screen structure 14 is unlatched. Urging system anchor 44 may be positioned on pivotal coupling structure 36 at a location off of pivotal axis 27 to increase the torque exerted by coil spring 58 about pivotal axis 27.

Video display system 10 also includes a position-fixing system 60 to allow a user to fix the position of screen structure 14 in any desired position within a continuous range of deployed positions. A typical range of deployed positions is between 45 and 150 degrees from the horizontal, and a more typical range is between 65 and 130 degrees from the horizontal, though wider or narrower ranges may also be used. Generally, position-fixing system 60 includes a first position-fixing member 62 and a second position-fixing member 64. First position-fixing member 62 is fixed in a stationary position on frame 26, and second position-fixing member 64 is coupled to body portion 42 so that it pivots relative to first position-fixing member 62 when screen structure 14 is pivoted. The two position-fixing members are configured to be in kissing contact with one another when screen structure 14 is within the range of deployed positions. The friction provided by the contact between position-fixing members 62 and 64 is sufficient to prevent screen structure 14 from being moved by gravity or coil spring 58, but does not prevent manual repositioning.

A suitable position-fixing system is shown in detail in FIG. 4. First position-fixing member 62 is disposed on frame 26 at a location near pivotal coupling structure 36. First position-fixing member 62 includes a continuously curved concave position-fixing surface 66 that faces body portion 42 of pivotal coupling structure 36. Second position-fixing member 64 is coupled to body portion 42 of pivotal coupling structure 36 so that it contacts first position-fixing member 62 when screen structure 14 is within the range of deployed positions.

Second position-fixing member 64 may have any suitable structure that provides a sufficient frictional contact with first position-fixing member to fix screen structure 14 in a desired position. In the depicted embodiment, second position-fixing member 64 includes a leaf spring coupled to pivotal coupling structure 36. Leaf spring 64 includes a mounting portion 70 for mounting leaf spring 64 to pivotal coupling structure 36, and a resilient portion 68 that contacts surface 62 when screen structure 14 is positioned within the range of possible deployed positions. Resilient portion 68 of leaf spring 64 is biased out of a rest state by contact with surface 62. Resilient portion 68 thus exerts pressure against curved surface 66, increasing the frictional force between the surface of resilient portion 68 and curved surface 66. In the depicted embodiment, the curvature of curved surface 66 is circular so that resilient portion 68 exerts the same pressure against curved surface 66 throughout the range of possible deployed positions. A passenger adjusting the position of screen structure 14 would thus feel the same resistance to screen movement throughout the range of possible deployed positions.

System 10 may optionally include other components not described above, such as an override system that allows a front seat passenger to control a function of system 10 to the exclusion of a rear seat passenger viewing system 10.

Another aspect of the present invention provides an automobile with a passenger cabin-mounted video display system that includes a stowable screen adjustable over a continuous range of deployed positions. Accordingly, the invented video display system is depicted in an automobile shown generally at 74 in FIG. 5. Automobile 74 includes a passenger compartment 76 with a ceiling 78, a front seat 80, a first rear seat 82 and a second rear seat 84. System 10 is mounted to ceiling 78 of passenger compartment 76 such that it is viewable by a passenger sitting in either rear seat 82 or 84.

System 10 includes base 12 coupled to ceiling 78, and screen structure 14 on which a video signal may be displayed. Screen structure 14 may be selectively stowed in or deployed from base 12 so that screen structure 14 may be either hidden from or presented to rear seat passengers. System 10 is positioned approximately between front seat 80 and first rear seat 82 so that a passenger sitting in first rear seat 82 may easily reach control device 16. Optionally, system 10 may be mounted approximately between first rear seat 82 and second rear seat 84 such that screen structure 14 is viewable and controllable only by passengers in second rear seat 84. Furthermore, a vehicle may have a separate system 10 for each seat, and each system 10 may have the same or a separate video source. Because passengers of different heights may view screen structure 14 from different seats within the car, screen 10 may be fixed at any angle within a continuous range of possible deployed positions relative to ceiling 78, as shown in FIG. 6.

It is believed that the disclosure set forth above encompasses multiple distinct inventions with independent utility. While each of these inventions has been disclosed in a selected form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A stowable video display system comprising:
a base;
a display screen pivotally coupled to the base, wherein the screen is pivotal about a pivot axis between a stowed position and a deployed position selected from a continuous range of deployed positions;
a pivotal coupling structure pivotally coupling the screen to the base, the pivotal coupling structure including a dampening mechanism adapted to dampen deployment of the screen;
a first position-fixing member mounted on the base; and
a second position-fixing member mounted on the pivotal coupling structure, the second position-fixing member being adapted to contact the first position-fixing member when the screen is deployed to hold the screen in any of the continuous range of possible deployed positions.

2. The display system of claim 1, wherein the second position-fixing member travels along the first position-fixing member as the screen is pivoted between deployed positions.

3. The display system of claim 1, wherein the first position-fixing member includes a curved surface adapted for selected contact with the second position-fixing member throughout the continuous range of possible deployed positions.

4. The display system of claim 3, wherein the first position-fixing member is in sliding frictional contact with the second position-fixing member surface throughout the continuous range of possible deployed positions.

5. The display system of claim 1, wherein the second position-fixing member includes a leaf spring.

6. The display system of claim 5, wherein the leaf spring contacts the first position-fixing member throughout the continuous range of possible deployed positions, and wherein the leaf spring is biased by the first position-fixing member so that the leaf spring exerts pressure against the first position-fixing member to frictionally hold the screen in any position within the continuous range of possible deployed positions.

7. The display system of claim 1, further comprising an urging system that urges the screen to pivot toward the continuous range of possible deployed positions.

8. The display system of claim 7, wherein the urging system includes a spring coupled between the base and the pivotal coupling structure such that the spring urges the pivotal coupling structure to pivot the screen away from the stowed position.

9. In an automobile including a passenger compartment having a ceiling, a video display system viewable by a passenger in the passenger compartment, the video display system comprising:
a display screen pivotally coupled to the ceiling for pivot about a pivot axis between a stowed position adjacent the ceiling and a deployed position within a continuous range of possible deployed positions in which the screen is viewable to the vehicle passenger;
a pivotal coupling structure coupling the screen to the ceiling, the pivotal coupling structure including a screen-coupling portion operatively attached to the screen, a pivot bar operatively attached to the ceiling, and a dampening mechanism to dampen the deployment of the screen relative to the ceiling;
a first position-fixing member operatively attached to the ceiling; and
a second position-fixing member operatively attached to the pivotal coupling structure, wherein the second position-fixing member is adapted to contact the first position-fixing member throughout the continuous range of deployed positions so that the screen is held in any position within the continuous range of possible deployed positions by the contact between the first position-fixing member and the second position-fixing member.

10. The automobile of claim 9, wherein the first position-fixing member includes a curved surface configured to be in slidable contact with the second position-fixing member such that the second position-fixing member slides along the curved surface as the screen travels throughout the range of deployed positions.

11. The automobile of claim 9, wherein the second position-fixing member includes a leaf spring adapted to be biased by contact with the first position-fixing member throughout the range of deployed positions to hold the screen in any of the range of deployed positions.

12. The display system of claim 9, further comprising an urging system that urges the screen to pivot toward the continuous range of possible deployed positions.

13. The display system of claim 12, wherein the urging system includes a spring coupled between the ceiling and the pivotal coupling structure such that the spring urges the pivotal coupling structure to pivot the screen away from the stowed position.

14. In an automobile including a passenger compartment with a rear seat and a ceiling, a ceiling-mounted video display system comprising:
a base attached to the ceiling of the passenger compartment, the base including a curved position-fixing surface;
a screen structure having a viewing surface, wherein the screen structure is pivotally coupled to the base such that the screen structure is pivotable between a stowed position adjacent the ceiling and a deployed position selected from a continuous range of possible deployed positions in which the viewing surface extends downwardly from the ceiling for viewing by a rear seat passenger;
a pivotal coupling structure pivotally coupling the screen to the base, the pivotal coupling structure including a screen-coupling portion attached to the screen structure, a pivot bar attached to the base, and a dampening mechanism to dampen the pivoting of the screen structure, wherein the pivotal coupling structure pivots with respect to the base when the screen structure is pivoted; and
a leaf spring disposed on the pivotal coupling structure such that the leaf spring is in slidable contact with the position-fixing surface throughout the continuous range of deployed screen structure positions to frictionally hold the screen structure in any one of the continuous range of deployed positions.
